(19) United States
(12) Patent Application Publication
(10) Pub. No.: US 2026/0030854 A1
(43) Pub. Date: Jan. 29, 2026

(54) DISPLAY CONTROL APPARATUS, METHOD, AND PROGRAM

(71) Applicants: Sony Interactive Entertainment Inc., Tokyo (JP); Sony Interactive Entertainment LLC, San Mateo, CA (US)

(72) Inventors: Yoshimi Nakada, Tokyo (JP); Daisuke Kawamura, Foster City, CA (US); Takahisa Kurose, Kanagawa (JP); Hideki Yanagisawa, Kanagawa (JP)

(73) Assignees: Sony Interactive Entertainment Inc., Tokyo (JP); Sony Interactive Entertainment LLC, 2207 Bridgepointe Pkwy, CA (US)

(21) Appl. No.: 19/269,737

(22) Filed: Jul. 15, 2025

Related U.S. Application Data
(60) Provisional application No. 63/676,493, filed on Jul. 29, 2024.

(51) Int. Cl. G06T 19/20; G06T 15/00

(52) U.S. Cl. CPC G06T 19/20; G06T 15/00; G06T 2219/2004

(57) ABSTRACT

Provided is a display control apparatus that controls display on a display unit, including a memory for storing a program code, and a processor for executing operation in accordance with the program code, the operation including causing the display unit to display a three-dimensional space, causing a first object movable in the three-dimensional space to be displayed, and causing at least one line visually indicating a position of the first object in the three-dimensional space to be displayed.

### BACKGROUND

The present invention relates to a display control apparatus, a method, and a program.

It is common practice to display a three-dimensional space on a display unit and move an object disposed in the three-dimensional space according to a user operation.

### SUMMARY

However, in a case where the object in the three-dimensional space is to be used as a pointer, for example, performing an accurate operation is sometimes not easy since it is difficult to visually recognize a position in a depth direction in the space, for example.

Accordingly, it is desirable to provide a display control apparatus, a method, and a program that enable easy recognition of a position of an object displayed in a three-dimensional space.

According to a mode of the present disclosure, there is provided a display control apparatus that controls display on a display unit, including a memory for storing a program code and a processor for executing operation in accordance with the program code. The operation includes causing the display unit to display a three-dimensional space, causing a first object movable in the three-dimensional space to be displayed, and causing at least one line visually indicating a position of the first object in the three-dimensional space to be displayed.

According to another mode of the present disclosure, there is provided a method for controlling display on a display unit, the method including, by operation executed by a processor in accordance with a program code stored in a memory, causing the display unit to display a three-dimensional space, causing a first object movable in the three-dimensional space to be displayed, and causing at least one line visually indicating a position of the first object in the three-dimensional space to be displayed.

According to a further mode of the present disclosure, there is provided a program for controlling display on a display unit, in which operation executed by a processor in accordance with the program includes causing the display unit to display a three-dimensional space, causing a first object movable in the three-dimensional space to be displayed, and causing at least one line visually indicating a position of the first object in the three-dimensional space to be displayed.

### BRIEF DESCRIPTION OF THE DRAWINGS

FIG. 1 is a diagram illustrating an example of a system according to an embodiment of the present disclosure;

FIG. 2 is a diagram illustrating an apparatus configuration example of the system illustrated in FIG. 1;

FIG. 3 is a diagram illustrating a first example of display on a display unit according to the embodiment of the present disclosure;

FIG. 4A is a diagram illustrating an example of display relating to another object in the first example;

FIG. 4B is a diagram illustrating an example of display relating to another object in the first example;

FIG. 5A is a diagram illustrating an example of display relating to another object in the first example;

FIG. 5B is a diagram illustrating an example of display relating to the other object in the first example;

FIG. 5C is a diagram illustrating an example of display relating to the other object in the first example;

FIG. 6 is a diagram illustrating a second example of display on the display unit according to the embodiment of the present disclosure;

FIG. 7 is a diagram for further describing display of a position of a pointer by use of grid lines; and

FIG. 8 is a diagram illustrating an example of display relating to another object in the second example.

### DETAILED DESCRIPTION OF THE PREFERRED EMBODIMENTS

Several embodiments of the present disclosure are described in detail below with reference to the accompanying drawings. It is to be noted that, in the present specification and drawings, constituent elements having substantially the same functional configuration are denoted by the same reference symbol and redundant description is omitted.

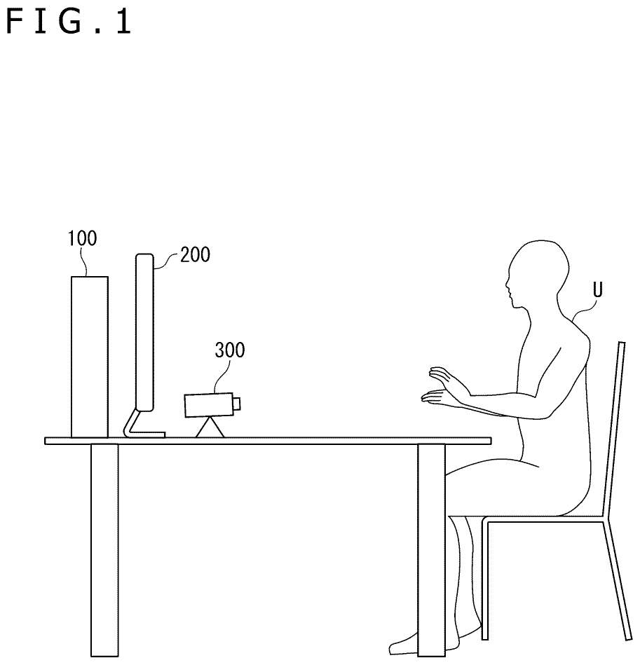

FIG. 1 is a diagram illustrating an example of a system according to an embodiment of the present disclosure. In the example illustrated, the system includes a computer 100, a display unit 200, and a camera unit 300. The computer 100 causes the display unit 200 to display a three-dimensional space containing an object that is to be described later. The camera unit 300 captures an image containing a user U as a subject, and the computer 100 uses, as an operation input, the user U′s gesture extracted from the image, to change the position or the like of the object displayed on the display unit 200. It is to be noted that the user may perform an operation input to the computer 100 not only by a gesture input using the camera unit 300 as in the illustrated example but also by use of a pointing device such as a mouse or a touch panel provided in the display unit 200. In such a case, the camera unit 300 does not necessarily need to be included in the system.

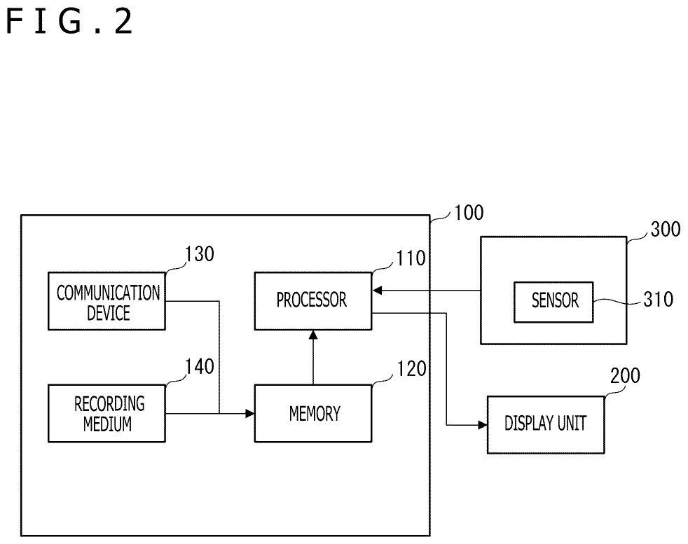

FIG. 2 is a diagram illustrating an apparatus configuration example of the system illustrated in FIG. 1. The computer 100 includes a processor 110 and a memory 120. The processor 110 is formed by a processing circuit such as a central processing unit (CPU), a digital signal processor (DSP), an application specific integrated circuit (ASIC), or a field-programmable gate array (FPGA), for example. The memory 120 is formed by various kinds of memory devices or storage devices such as a read only memory (ROM), a random access memory (RAM), or a hard disk drive (HDD), for example. The processor 110 operates in accordance with a program code stored in the memory 120. The computer 100 may further include a communication device 130 and a recording medium 140. The program code may be received through the communication device 130 from an external device or may be read out from the recording medium 140 and stored into the memory 120. The recording medium 140 includes a semiconductor memory, a magnetic disk, an optical disk, or a magneto-optical disk, for example.

The computer 100 is an example of a display control apparatus that executes display control of the display unit 200 as described below. In the computer 100, the processor 110 executes such operations for display control as described below, in accordance with the program code stored in the memory 120. The computer 100 may be implemented as an apparatus like a game machine or a personal computer (PC), for example. In this case, the display unit 200 is incorporated in the computer 100 or is connected to the computer 100 by cables or in a wireless manner. Alternatively, at least some of the functions of the computer 100 may be implemented by a server apparatus on a network. In this case, the display unit 200 or the apparatus that implements some of the functions of the computer 100 is connected to the server apparatus through a wired or wireless network. As the display unit 200, there is used a flat display unit, a wearable display unit, or a projector that uses a liquid crystal display (LCD) or organic electro-luminescence (EL), for example.

The camera unit 300 includes a sensor 310 and captures an image to be included under the control of the processor 110 of the computer 100. As the sensor 310, there is used, either alone or in combination, a frame-based vision sensor such as a CMOS image sensor or a CCD image sensor, an event-based vision sensor called an event vision sensor (EVS), an event driven sensor (EDS), or a dynamic vision sensor (DVS), or a ranging sensor such as a direct time of flight (dToF) sensor or an indirect time of flight (iToF) sensor, for example. It is to be noted that, as described above, the user may perform an operation input to the computer 100 not only by a gesture input but also by use of the pointing device or the like such as the mouse or the touch panel. In this case, in place of or in addition to the camera unit 300, the pointing device or the like is connected to the computer 100.

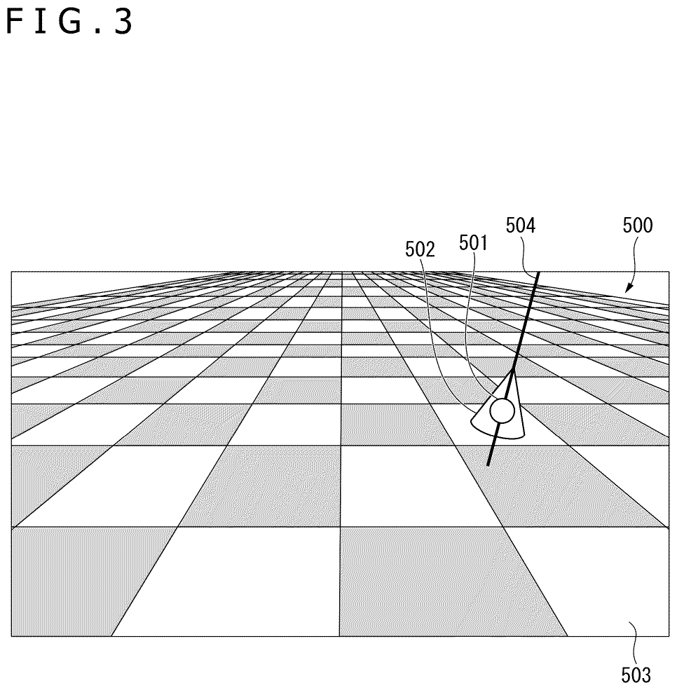

FIG. 3 is a diagram illustrating a first example of display on the display unit according to the embodiment of the present disclosure. In the illustrated example, a three-dimensional space 500 is displayed on the display unit 200 of the system illustrated in FIG. 1, and a pointer 501 is disposed in the three-dimensional space 500. The three-dimensional space 500 is a virtual space spreading in a horizontal direction (left-right direction), a vertical direction (up-down direction), and a depth direction and is drawn using perspective projection, for example. The pointer 501 is an example of a first object that is movable in the three-dimensional space, and is moved in the horizontal direction, the vertical direction, and the depth direction in the three-dimensional space 500 according to a gesture input made using the camera unit 300 or an operation input made using the pointing device, for example. The pointer 501 may also be capable of dragging another object 502 by a gesture, a button operation, or a long-press operation, for example.

In the first example described above, a floor surface 503 and a vertical line 504 are further displayed in the three-dimensional space 500. The floor surface 503 is an example of a second object fixed in the three-dimensional space and is drawn as a plane including the horizontal direction and the depth direction of the three-dimensional space 500. Meanwhile, the vertical line 504 is a straight line displayed between the pointer 501 and the floor surface 503. The user can visually recognize a position of the pointer 501 in the horizontal direction and the depth direction in the three-dimensional space 500, based on a point of intersection between the vertical line 504 and the floor surface 503. Displaying a checker pattern or grid lines on the floor surface 503 as in the example illustrated, for example, makes it easier to recognize the position in the horizontal direction and the depth direction on the floor surface 503. In addition, the user can visually recognize the position of the pointer 501 in the vertical direction in the three-dimensional space 500, based on a length of the vertical line 504. Thus, in this first example, the vertical line 504 is a line that visually indicates the position of the pointer 501 in the three-dimensional space 500.

It is to be noted that the vertical line 504 is a straight line that does not necessarily extend in the vertical direction based on a display area of the display unit 200 and extends in the vertical direction based on a coordinate system of the drawn three-dimensional space 500. Hence, the drawn vertical line 504 may not necessarily be perpendicular to the display area of the display unit 200, or may not even be a straight line. Further, the vertical line 504 may be displayed as extending from the pointer 501 also to a side opposite to the floor surface 503 as in the example illustrated. The vertical line 504 may also be displayed in a transmissive manner with respect to the pointer 501 and the floor surface 503, and in this case, the vertical line 504 is displayed as having an infinite length in the vertical direction. In this case as well, as in the example described above, with a transmissive display portion of the vertical line 504 being displayed in a manner different from those of other portions thereof, the position of the pointer 501 in the three-dimensional space 500 can visually be recognized with use of the floor surface 503 and the vertical line 504. Moreover, although the vertical line 504 is illustrated as penetrating the inside of the pointer 501, the vertical line 504 may alternatively be displayed as passing through a vicinity of the pointer 501.

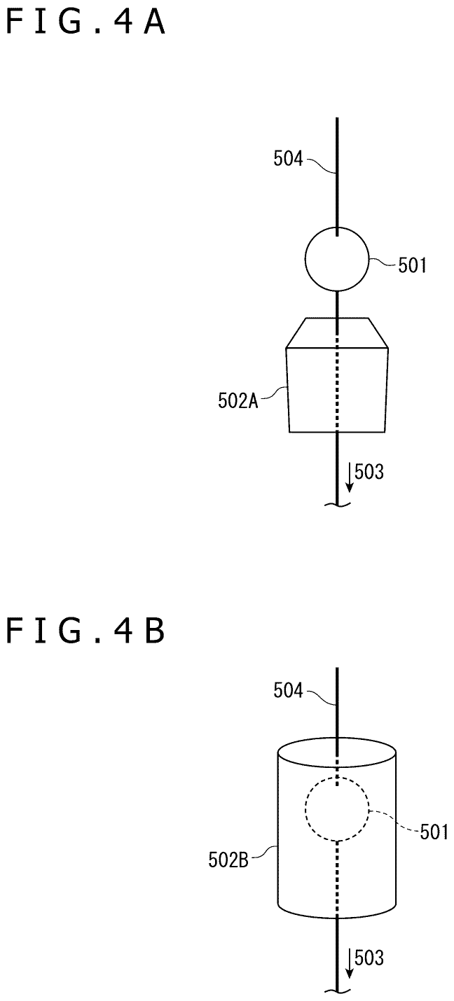

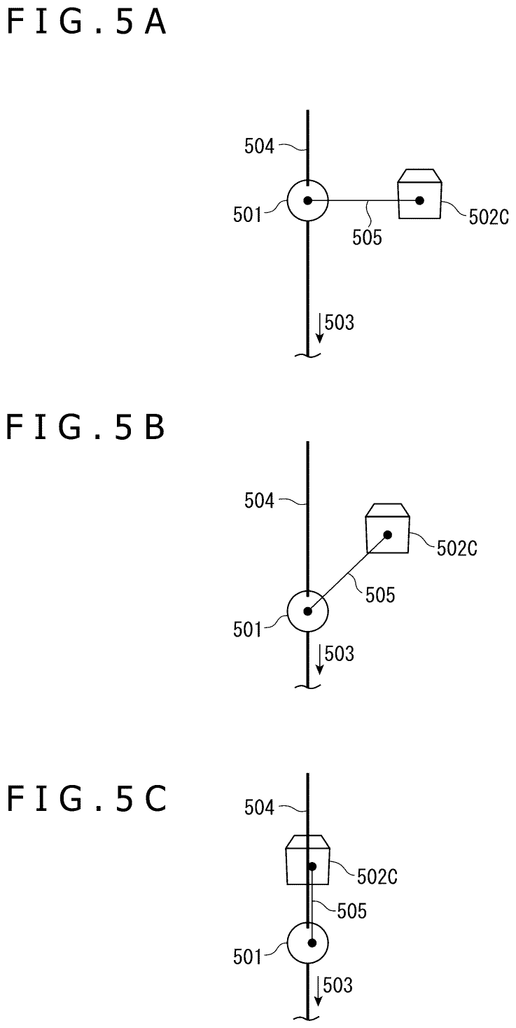

FIG. 4A, FIG. 4B, and FIG. 5A through FIG. 5C are diagrams illustrating examples of display relating to another object in the first example. For example, in a case where there is another object 502A on the vertical line 504 extending through the pointer 501 as in the example of FIG. 4A, the vertical line 504 may be displayed as penetrating the object 502A and extending up to the floor surface 503. Alternatively, the vertical line 504 may be displayed between the pointer 501 and the object 502A but not beyond the object 502A up to the floor surface 503. In this case, the object 502A is an example of the second object fixed in the three-dimensional space. Displaying the vertical line 504 between the pointer 501 and the object 502A allows the user to visually recognize the position of the pointer 501 in the three-dimensional space 500 as a position relative to the object 502A. Meanwhile, in a case where the pointer 501 overlaps another object 502B as in the example of FIG. 4B, the vertical line 504 may not be displayed for a portion extending in the object 502B and may be displayed between a surface of the other object 502B and the floor surface 503. In this case as well, the vertical line 504 is displayed between the pointer 501 and the floor surface 503 except for the portion thereof hidden by the other object 502B.

In the examples illustrated in FIG. 5A through FIG. 5C, the vertical line 504 is displayed between the pointer 501 and the floor surface 503, and, in addition, an additional straight line 505 is displayed between the pointer 501 and another object 502C when a predetermined positional relation is established between the pointer 501 and the other object 502C. In this case, the other object 502C is an example of a third object fixed in the three-dimensional space. The additional straight line 505 is displayed between the pointer 501 and the object 502C in, for example, a case where the pointer 501 and the object 502C are aligned with each other in the horizontal direction as illustrated in FIG. 5A, a case where the pointer 501 and the object 502C are aligned with each other at a predetermined angle (45° in the illustrated example) in an oblique direction as illustrated in FIG. 5B, or a case where the pointer 501 and the object 502C are aligned with each other in the vertical direction as illustrated in FIG. 5C. Such display allows the user to visually recognize not only the position of the pointer 501 in the three-dimensional space 500 but also a relative positional relation between the pointer 501 and the other object 502C.

It is to be noted that the second and third objects being fixed in the three-dimensional space in the respective examples described above does not necessarily mean that the second object is always fixed. In a case where a drag operation using the pointer 501 is performed in the above example, for example, the object 502A may move together with the pointer 501. Further, in a case where a point of view is moved or changed in the three-dimensional space 500, for example, the position of the floor surface 503 is also changed in the three-dimensional space 500 thus drawn.

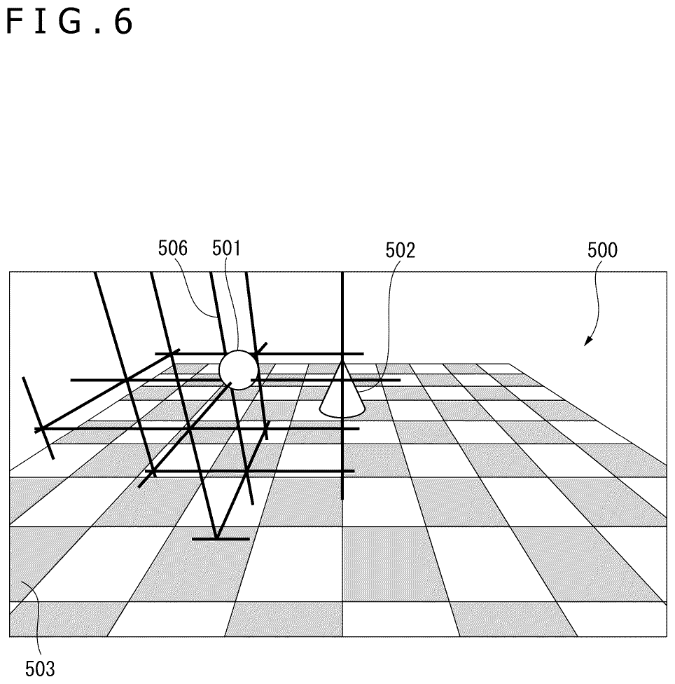

FIG. 6 is a diagram illustrating a second example of display on the display unit according to the embodiment of the present disclosure. In the example illustrated, in addition to the three-dimensional space 500, the pointer 501, and the floor surface 503 similar to those in the example of FIG. 3, grid lines 506 are displayed on the display unit 200 of the system illustrated in FIG. 1. The grid lines 506 include straight lines extending in the horizontal direction, the vertical direction, and the depth direction orthogonally intersecting each other in the three-dimensional space 500. In the example of FIG. 6, the grid lines 506 are displayed over a range from a vicinity of the pointer 501 to the floor surface 503. In this case, the user can visually recognize the position of the pointer 501 in the horizontal direction and the depth direction in the three-dimensional space 500, based on points of intersection between the grid lines 506 and the floor surface 503. In addition, the user can visually recognize the position of the pointer 501 in the vertical direction in the three-dimensional space 500, based on lengths of the grid lines 506 in the vertical direction or the number of grids defined by the grid lines 506. Hence, in this second example, the grid lines 506 are lines for visually indicating the position of the pointer 501 in the three-dimensional space 500.

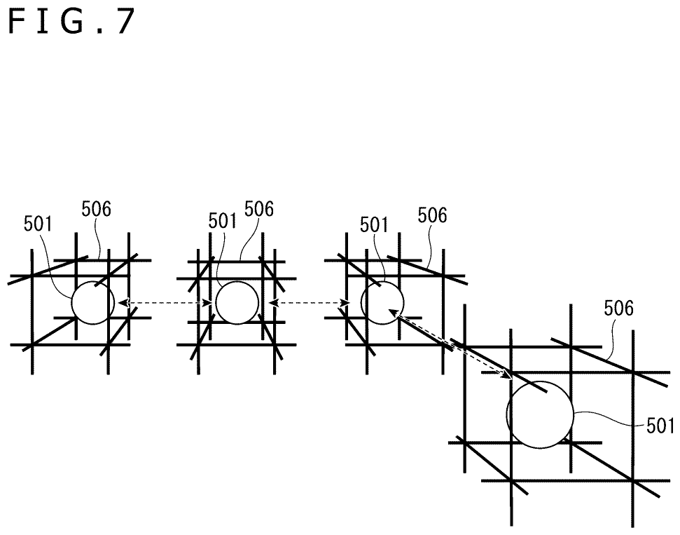

FIG. 7 is a diagram for further describing the display of the position of the pointer by use of the grid lines. As illustrated, since the grid lines 506 are constituted by the straight lines extending in the horizontal direction, the vertical direction, and the depth direction in the three-dimensional space 500, when the position of the pointer 501 changes, angles formed by the respective lines constituting the grid lines 506 change in accordance with the perspective projection based on which the three-dimensional space 500 is drawn. Hence, the user can visually recognize the position of the pointer 501 in the horizontal direction, the vertical direction, and the depth direction in the three-dimensional space 500, based on also the angles of the grid lines 506. Therefore, in the case where the grid lines 506 are displayed as the lines visually indicating the position of the pointer 501 in the three-dimensional space 500, the floor surface 503 does not necessarily need to be displayed.

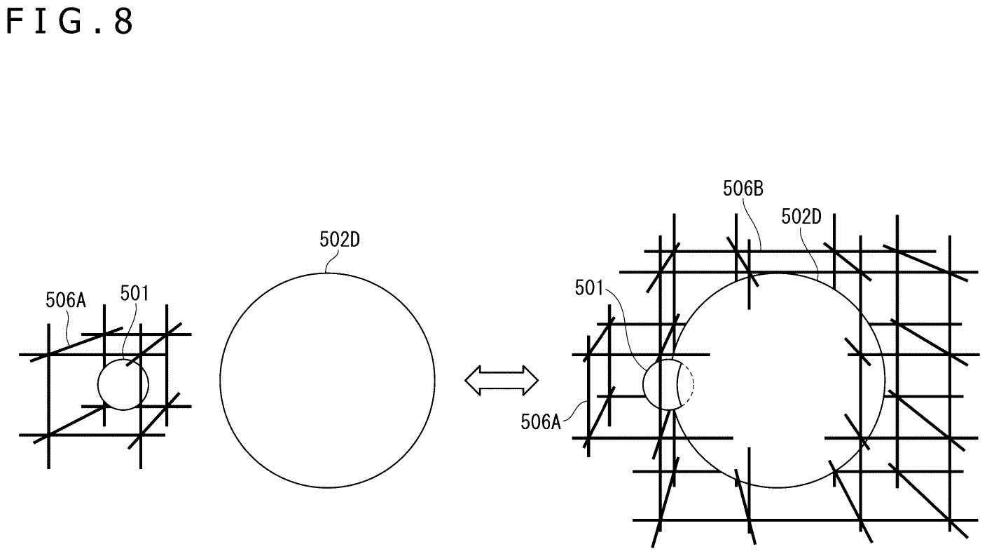

FIG. 8 is a diagram illustrating an example of display relating to another object in the second example. In the example illustrated, grid lines 506A are displayed in the vicinity of the pointer 501. Initially, there are no grid lines displayed in a vicinity of another object 502D, but when the pointer 501 approaches the other object 502D, grid lines 506B also appear in the vicinity of the other object 502D. Processing executed in this example is such that, when a distance between the pointer 501 and the other object 502D exceeds a threshold value, the grid lines 506A are displayed only in the vicinity of the pointer 501, and when the distance between the pointer 501 and the other object 502D is equal to or smaller than the threshold value, the grid lines 506A and 506B are displayed in the vicinity of the pointer 501 and the vicinity of the other object 502D. Such display allows the user to visually recognize not only the position of the pointer 501 in the three-dimensional space 500 but also a relative positional relation between the pointer 501 and the other object 502D.

The embodiments of the present disclosure have been described above in detail with reference to the accompanying drawings, but the present disclosure is not limited to such embodiments. It is obvious that any person having ordinary knowledge of the technical field to which the present disclosure pertains can conceive of various alterations and modifications within the scope of the technical ideas described in the claims. Such alterations and modifications are also naturally construed as belonging to the technical scope of the present disclosure.

### SUMMARY OF PRESENT DISCLOSURE

A summary of the present disclosure is noted below.

[1] A display control apparatus that controls display on a display unit, including:
a memory for storing a program code; and
a processor for executing operation in accordance with the program code,
the operation including
causing the display unit to display a three dimensional space,
causing a first object movable in the three-dimensional space to be displayed, and
causing at least one line visually indicating a position of the first object in the three-dimensional space to be displayed.
[2] The display control apparatus according to [1],
in which the operation further includes causing a second object fixed in the three-dimensional space to be displayed, and
the at least one line includes a straight line displayed at least between the first object and the second object.
[3] The display control apparatus according to [2], in which the second object includes a floor surface.
[4] The display control apparatus according to [2] or [3], in which the operation further includes
causing a third object fixed in the three-dimensional space to be displayed, and,
in a case where the first object has a predetermined positional relation with the third object, causing a line different from the at least one line to be displayed between the first object and the third object.
[5] The display control apparatus according to [4], in which the predetermined positional relation includes alignment in a horizontal direction, alignment in a vertical direction, or alignment at a predetermined angle in an oblique direction.
[6] The display control apparatus according to [1], in which the at least one line includes grid lines extending in directions orthogonal to each other in the three-dimensional space.
[7] The display control apparatus according to [6], in which the grid lines are displayed over a range from a vicinity of the first object to a floor surface.
[8] The display control apparatus according to [6], in which the grid lines are displayed only in a vicinity of the first object.
[9] The display control apparatus according to [8],
in which the operation further includes causing a second object fixed in the three-dimensional space to be displayed, and
the grid lines are displayed only in the vicinity of the first object in a case where a distance between the first object and the second object exceeds a threshold value, and displayed not only in the vicinity of the first object but also in a vicinity of the second object in a case where the distance is equal to or smaller than the threshold value.
[10] A method for controlling display on a display unit, the method including:
by operation executed by a processor in accordance with a program code stored in a memory,
causing the display unit to display a three-dimensional space;
causing a first object movable in the three-dimensional space to be displayed; and
causing at least one line visually indicating a position of the first object in the three-dimensional space to be displayed.
[11] A program for controlling display on a display unit,
in which operation executed by a processor in accordance with the program includes
causing the display unit to display a three-dimensional space,
causing a first object movable in the three-dimensional space to be displayed, and
causing at least one line visually indicating a position of the first object in the three-dimensional space to be displayed.

1. A display control apparatus that controls display on a display unit, comprising:
one or more processors; and
one or more memories storing computer-readable instructions that, upon execution by the one or more processors, configure the display control apparatus to:
display a three-dimensional space;
display a first object movable in the three-dimensional space; and
display at least one line visually indicating a position of the first object in the three-dimensional space.

2. The display control apparatus according to claim 1, the display control apparatus is further configured to:
display a second object fixed in the three-dimensional space wherein the at least one line includes a straight line displayed at least between the first object and the second object.

3. The display control apparatus according to claim 2, wherein the second object includes a floor surface.

4. The display control apparatus according to claim 2, the display control apparatus is further configured to:
display a third object fixed in the three-dimensional space; and
in a case where the first object has a predetermined positional relation with the third object, display a line different from the at least one line between the first object and the third object.

5. The display control apparatus according to claim 4, wherein the predetermined positional relation includes alignment in a horizontal direction, alignment in a vertical direction, or alignment at a predetermined angle in an oblique direction.

6. The display control apparatus according to claim 1, wherein the at least one line includes grid lines extending in directions orthogonal to each other in the three-dimensional space.

7. The display control apparatus according to claim 6, wherein the grid lines are displayed over a range from a vicinity of the first object to a floor surface.

8. The display control apparatus according to claim 6, wherein the grid lines are displayed only in a vicinity of the first object.

9. The display control apparatus according to claim 8, the display control apparatus is further configured to:
display a second object fixed in the three-dimensional space; and
in a case where a distance between the first object and the second object exceeds a threshold value, display the grid lines only in the vicinity of the first object; and
in a case where the distance is equal to or smaller than the threshold value, display the grid line not only in the vicinity of the first object but also in a vicinity of the second object.

10. A method for controlling display on a display unit, the method comprising:
displaying a three-dimensional space;
displaying a first object movable in the three-dimensional space; and
displaying at least one line visually indicating a position of the first object in the three-dimensional space to be displayed.

11. One or more non-transitory computer-readable storage media storing instructions that, upon execution on a computer system, cause the computer system to perform operations comprising:
displaying a three-dimensional space;
displaying a first object movable in the three-dimensional space; and
displaying at least one line visually indicating a position of the first object in the three-dimensional space.

12. The method of claim 10, the method further comprising:
displaying a second object fixed in the three-dimensional space wherein the at least one line includes a straight line displayed at least between the first object and the second object.

13. The method of claim 12, wherein the second object includes a floor surface.

14. The method of claim 10, the method further comprising:
displaying a third object fixed in the three-dimensional space; and
in a case where the first object has a predetermined positional relation with the third object, displaying a line different from the at least one line between the first object and the third object.

15. The method of claim 14, wherein the predetermined positional relation includes alignment in a horizontal direction, alignment in a vertical direction, or alignment at a predetermined angle in an oblique direction.

16. The method of claim 10, wherein the at least one line includes grid lines extending in directions orthogonal to each other in the three-dimensional space.

17. The one or more non-transitory computer-readable storage media of claim 11, wherein the operations further comprise:
displaying a second object fixed in the three-dimensional space wherein the at least one line includes a straight line displayed at least between the first object and the second object.

18. The one or more non-transitory computer-readable storage media of claim 17, wherein the second object includes a floor surface.

19. The one or more non-transitory computer-readable storage media of claim 11, wherein the operations further comprise:
displaying a third object fixed in the three-dimensional space; and
in a case where the first object has a predetermined positional relation with the third object, displaying a line different from the at least one line between the first object and the third object.

20. The one or more non-transitory computer-readable storage media of claim 19, wherein the predetermined positional relation includes alignment in a horizontal direction, alignment in a vertical direction, or alignment at a predetermined angle in an oblique direction.
